(19) United States
(12) Patent Application Publication
(10) Pub. No.: US 2006/0069850 A1
(43) Pub. Date: Mar. 30, 2006

(54) Methods and apparatus to perform a reclaim operation in a nonvolatile memory

(76) Inventor: John C. Rudelic, Folsom, CA (US)

Correspondence Address: INTEL CORPORATION, P.O. BOX 5326, SANTA CLARA, CA, 95056-5326, US

(21) Appl. No.: 10/957,469

(22) Filed: Sep. 30, 2004

(51) Int. Cl. G06F 12/00; G06F 12/08

(52) U.S. Cl. 711/103; 711/203

(57) ABSTRACT

A method and apparatus to perform a reclaim operation in a nonvolatile memory is provided. The apparatus may be a nonvolatile memory that may include a control circuit to receive a reclaim request from a device external to the nonvolatile memory and to perform a reclaim operation in response to receiving the reclaim request, wherein the reclaim operation includes copying valid information stored in a first portion of the nonvolatile memory to a second portion of the nonvolatile memory and erasing the first portion of the nonvolatile after the copying of the valid information. Other embodiments are described and claimed.

### BACKGROUND

Nonvolatile memories such as, for example, a flash electrically erasable programmable read-only memory (“flash EEPROM” or “flash memory”) may retain their data until the memory is erased. Flash memory may be arranged as blocks of single transistor memory cells that may include a floating gate to store information. Although a flash memory is rewritable, the memory cells may not be re-programmed unless they have first been erased. Further, the flash memory cells may only be erasable in blocks. Thus in order to erase one cell, an entire block of cells may have to be erased. Erasing a block of flash memory may be a relatively time consuming process. For example, in some flash memories, the erasing of a block of memory may take approximately one second.

Due to the characteristics of flash memory, including the relatively long time needed to erase a block, in some flash memories when data stored in the memory is updated, the new data may be written to a new location and the older version of the data may be invalidated and remain in the memory and not erased until a later point in time. However, the older version of the data takes up space in the memory, and as more updates are performed, the amount of invalid data may increase resulting in less memory space for new data.

### BRIEF DESCRIPTION OF THE DRAWINGS

FIG. 1 is a block diagram illustrating a portion of a computing system in accordance with an embodiment of the present invention;

FIG. 2 is a diagram illustrating a block of memory in accordance with an embodiment of the present invention;

FIG. 3 is a diagram illustrating the block of memory of FIG. 2 after one or more write operations;

FIG. 4 is a diagram illustrating the block of memory of FIG. 3 one or more write operations to write data to the block of memory and after one or more write operations to invalidate data stored in the block of memory;

FIG. 5 is a flow diagram illustrating a method in accordance with an embodiment of the present invention;

FIG. 6 is a diagram illustrating the memory blocks of the memory shown in FIG. 1;

FIG. 7 is a diagram illustrating the memory blocks of the memory shown in FIG. 1 at a later point in time;

FIG. 8 is a flow diagram illustrating a method in accordance with an embodiment of the present invention;

FIG. 9 is a diagram illustrating colonies of a selected reclaim block and their corresponding colony status cells prior to a reclaim operation in accordance with an embodiment of the present invention;

FIG. 10 is a diagram illustrating colonies of a spare block and their corresponding colony status cells after the reclaim operation in accordance with an embodiment of the present invention; and

FIG. 11 is a block diagram illustrating a wireless device in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the present invention. However, it will be understood by those skilled in the art that the present invention may be practiced without these specific details. In other instances, well-known methods, procedures, components and circuits have not been described in detail so as not to obscure the present invention.

In the following description and claims, the terms “include” and “comprise,” along with their derivatives, may be used, and are intended to be treated as synonyms for each other. In addition, in the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Further, “coupled” may mean that two or more elements are indirectly joined together, for example, via one or more other elements.

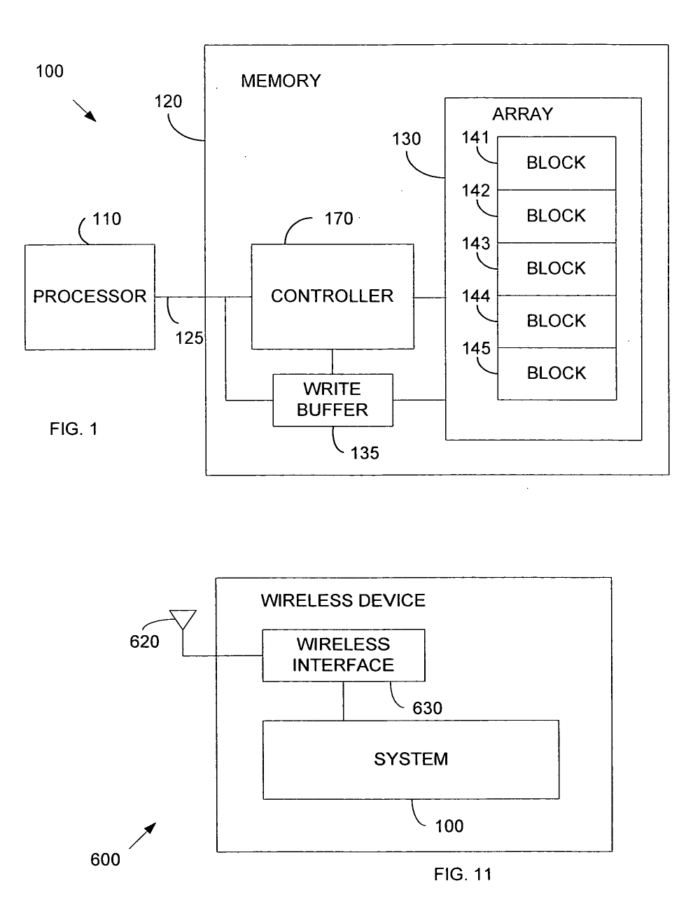

FIG. 1 is a block diagram illustrating a portion of a computing system 100 in accordance with an embodiment of the present invention. Although the scope of the present invention is not limited in this respect, system 100 may be used in a personal digital assistant (PDA), a wireless telephone (for example, cordless or cellular phone), a pager, a digital music player, a laptop or desktop computer, a set-top box, a printer, etc.

System 100 may include a processor 110 and a nonvolatile memory 120 coupled to processor 110 via a bus 125. Bus 125 may include one or more busses and may be a single 16-bit bus in one embodiment. Although not shown, system 100 may include other components such as, for example, more processors, input/output (I/O) devices, memory devices, or storage devices. However, for simplicity these additional components have not been shown.

In one embodiment, processor 110 may be a discrete component or device and may be external to nonvolatile memory 120. Processor 110 may include digital logic to execute software instructions and may also be referred to as a central processing unit (CPU). Software instructions executed by processor 110 may be stored in nonvolatile memory 120 and may also be referred to as code.

One example of software executed by processor 110 includes memory management software that may be used to manage the storage of code, data, and files in the nonvolatile memory. Memory management software may also be referred to in various embodiments as code management software, data management software, file management software, file system software, file system driver software, file system management software, flash file management software, or a flash media manager.

Although not shown, processor 110 may include a CPU core that may comprise an arithmetic-logic unit (ALU) and registers. In one embodiment, processor 110 may be an XScale® microprocessor available from Intel® Corporation (both XScale and Intel are a registered trademarks of Intel Corporation). The XScale® microprocessor may be a 32-bit microprocessor that may include an ARM based core, although the scope of the present invention is not limited in this respect. Embodiments of the present invention may be used with other microprocessors having cores other than an ARM based core, for example, a MIPS based core, x86 based core, etc.

In some embodiments, nonvolatile memory 120 may be a NAND or NOR type of flash memory, and may be a single bit per cell capable of storing one bit of information per memory cell or multiple bits per cell memory capable of storing more than one bit of information per memory cell. Nonvolatile memory 120 may comprise one or more chips or integrated circuits (ICs). Although nonvolatile memory 120 is discussed as a flash memory, this is not a limitation of the present invention. In other embodiments, nonvolatile memory 120 may be another type of memory capable of storing data when power is removed from the memory. For example, nonvolatile memory 120 may be a ferroelectric random access memory (FRAM), a magnetic random access memory (MRAM), or any other nonvolatile device capable of storing code and/or data.

The term “information” may be used to refer to data, instructions, or code. Information may be stored in the nonvolatile memory either contiguously or in fragments. Examples of data may include a serial number of a device or encryption keys. If system 100 is used in a wireless telephone, examples of data may include ring tone data or telephone number data. Examples of code may include a software application (for example, a downloadable computer game), an operating system (O/S), a java applet, or libraries used by the operating system.

Nonvolatile memory 120 may store both code and data and may store code in one partition of memory 120 and may store data in another partition of memory 120. Each partition of nonvolatile memory 120 may comprise a plurality of blocks of memory, wherein each block includes a plurality of memory cells capable of storing at least one bit of information. The partition of nonvolatile memory 120 where data is stored may include one or more blocks and may be referred to as the data volume of nonvolatile memory 120. The partition of nonvolatile memory 120 where code is stored may include one or more blocks and may be referred to as the code volume of nonvolatile memory 120.

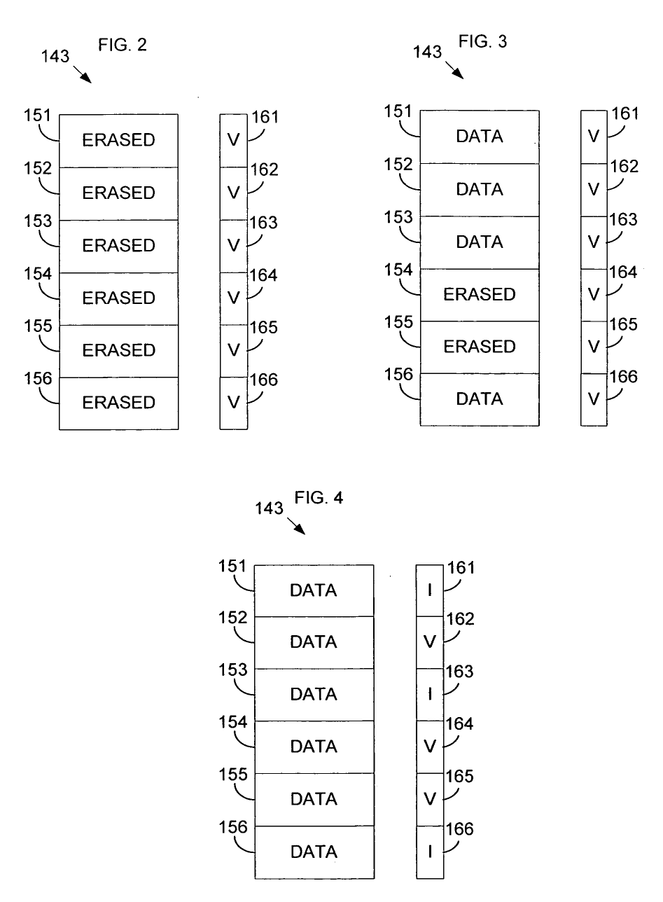

Nonvolatile memory 120 may include a memory array 130 which may include a plurality of blocks of memory 141-145. Turning briefly to FIG. 2, a block of memory, for example, block 143, may be subdivided into a plurality of colonies 151-156, wherein each colony includes a plurality of nonvolatile memory cells (not shown), for example, flash memory cells. Nonvolatile memory 120 may further include colony status cells 161-166, wherein each status cell is associated with, or corresponds to one colony. For example, status cells 161-166 may respectively correspond to colonies 151-156.

In one embodiment, each status cell may be a single nonvolatile memory cell, for example, a flash memory cell that may be used to store a status bit to indicate whether the corresponding colony includes valid or invalid information. The status cells associated with a block of memory may be stored within the associated block of memory or somewhere else in memory 120.

Turning back to FIG. 1, nonvolatile memory 120 may also include internal resources such as, for example, hardware and optionally code, that may be used to perform a reclaim operation, which may be used to reclaim space occupied by invalid data in memory 120. For example, nonvolatile memory 120 may include a controller 170 that may include circuitry, for example, digital logic, and may optionally execute code such as, for example, software or microcode that may be used to perform reclaim functions. Microcode may also be referred to as firmware.

Controller 170 may also be used to perform various control activities for memory 120. For example, in addition to reclaim operations, controller 170 may also be used to perform writing, erasing, and reading operations in memory 120 in response to write, erase, or read commands from a processor external to memory 120, for example, processor 110.

The reclaim operation may also be referred to as a reclaim function or a reclaim mechanism. Controller 170 may also be referred to as a control circuit and in various embodiments may be a state machine, an application specific integrated circuit (ASIC), or a processor such as, for example, a microprocessor, co-processor, or a microcontroller. In one embodiment, controller 170 may be a 8-bit microcontroller.

Memory 120 may further include a write buffer 135 that may be used for writing to memory 120. In some embodiments, write buffer 135 may be coupled to controller 170 and array 130 and may be capable of storing at least about 64 bytes of information. In other embodiments, write buffer 135 may be about 512 bytes in size, about one kilobyte in size or about two kilobytes (Kbytes) in size, although the scope of the present invention is not limited in this respect.

Although array 130 is shown as having five blocks of memory, wherein each block includes six colonies and each colony has one corresponding status cell, this is not a limitation of the present invention. In other embodiments, memory 120 may include at least about 128 blocks of memory and a block of memory may range in size from about 16 kilobytes (Kbytes) to about one megabyte (Mbyte).

A memory block of array 130 may be subdivided into colonies and may correspond in size to the size of write buffer 135. A colony may include a plurality of nonvolatile memory cells and may range in size from about 512 bytes to about two kilobytes. A colony may also be referred to as a sector of memory. In addition, in other embodiments, more than one colony status cell and/or more than one colony status bit may be used to indicate whether a colony includes valid or invalid information.

FIGS. 2-5 illustrate block 143 at various points in time during operation of system 100. FIG. 2 illustrates block 143 at an initial state, for example, after block 143 has been erased. An erase operation to block 143 may be initiated by memory management software running or executing on processor 110, or block 143 may be erased as part of a reclaim operation performed by memory 120 as discussed below. After an erase operation, colonies 151-156 may includes all logic ones and the corresponding colony status bits stored in status cells 161-166 may be set to a valid state, for example, a logic one. In the figures, a valid state is labeled “V” and an invalid state is labeled “I”.

FIG. 3 illustrates memory block 143 after one or more write operations to block 143. For example, a user of system 100 may initiate a command to store a file in memory 120. In an embodiment wherein write buffer 135 and the colonies of array 130 are one Kbyte in size, the memory management software executing on processor 110 may break the file into one Kbyte fragments. The fragments of the file may span across more than one block in array 130. In one example, four fragments of a data file are written to block 143 in erased colonies 151, 152, 153, and 156 as is illustrated in FIG. 3. The status bits stored in the corresponding status cells 161, 162, 163, and 166 remain unchanged, that is, in a valid state after a write operation to an erased colony.

FIG. 4 illustrates memory block 143 after one or more write operations to write data to colonies 154 and 155, and after one or more write operations to invalidate data stored in colonies 151, 153, and 156. The write operation to colonies 154 and 155 may be similar to the write operation described above with reference to FIG. 3, wherein data is written to erased colonies 154 and 155 by memory management software and the state of the corresponding colony status bits in status cells 164 and 165 remain unchanged.

The memory management software executing on processor 110 may change the state of the colony status bits in status cells 161, 163, and 166 to invalid. As an example, the status bits in cells 161, 163, and 166 may be changed to invalid in response to a user of system 100 deleting a file, resulting in the corresponding fragments of the deleted file that are stored in colonies 151,153, and 156 to become invalid. As another example, a user of system 100 may update a file with a newer version and in response, the updated file may be fragmented into, for example, one kilobyte fragments that may be written into erased colonies of array 130. The fragments that correspond to the older version of the file may be invalidated.

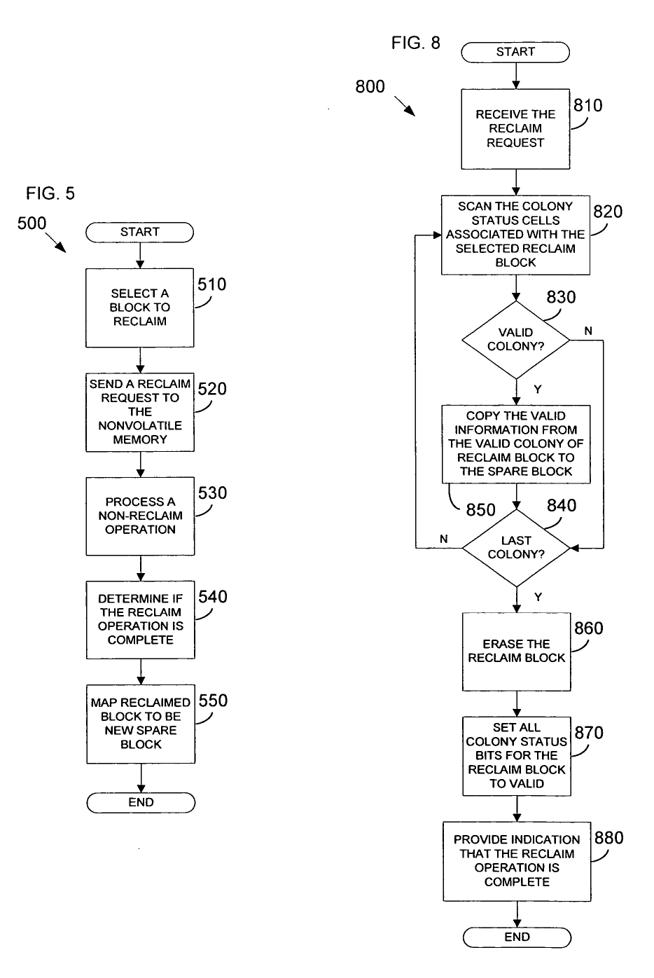

Turning to FIG. 5, what is shown is a flow diagram illustrating a method 500 to initiate a reclaim operation in a nonvolatile memory in accordance with an embodiment of the present invention. This method will be described with reference to system 100 of FIG. 1.

In one embodiment, all steps of method 300 may be performed by memory management software executing on processor 110. The memory management software may be stored in memory 120.

Method 500 may begin with selecting a memory block to reclaim (flow diagram block 510). This may be performed by memory management software executing on processor 110. The memory management software may maintain block information such as, for example, logical block numbering and also mapping of the logical blocks to physical blocks.

The memory management software may select a particular memory block for reclaiming based on metrics that the memory management software maintains. For example, the memory management software may be able to read status information for each colony of a block to determine whether the colony includes valid or invalid information. The memory management software may select the block having the most invalid information for reclaiming. The block of array 130 having the most invalid information may be referred to as the “dirtiest” block of memory in array 130.

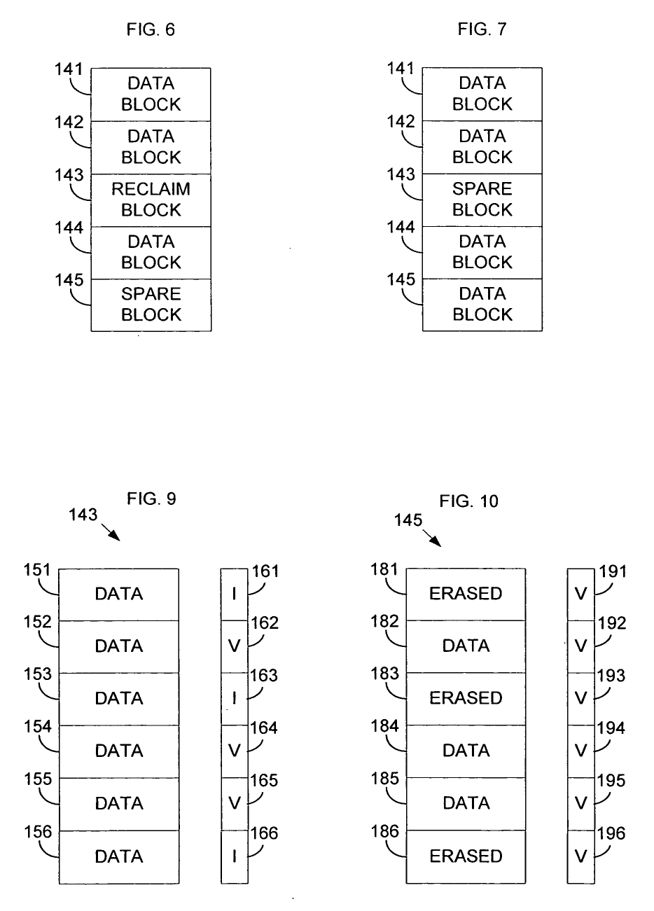

Turning to FIG. 6, blocks 141-145 of array 130 are illustrated. In one example, blocks 141-144 are mapped for storing data, and block 145 is a “spare” block that may be used for reclaiming memory space in memory 120. The designation and mapping of certain blocks as available for storing data and another block as a spare block may be managed by memory management software executing on processor 110. This software may store tables in memory 120 for the mapping of the memory blocks of array 130.

The spare block is an erased block and may be generated from a previous reclaim operation. In some embodiments, by using the previously reclaimed block as the spare block, this may result in improved wear leveling in memory 120 as the same physical block may not be repeatedly used for the reclaim operation, rather the actual physical block used for the spare block floats around within memory 120.

In one example, block 143 may be identified by the software executing on processor 110 as the dirtiest block of memory in array 130 and may be selected for reclaiming. Accordingly, block 143 may be referred to as a targeted or selected reclaim block, or simply a reclaim block.

Turning back to FIG. 5, after the reclaim block is selected by the software running on processor 110, the software may send a reclaim request to nonvolatile memory 120 (flow diagram block 520) via bus 125. The reclaim request may include a reclaim block address that indicates which block is selected for reclaiming and a spare block address that indicates which block is to be used as the spare block. In some embodiments, the reclaim block address may be any address within a range of addresses that correspond to the selected reclaim block 143.

The reclaim operation may then be processed or performed using hardware and optionally software resources internal to nonvolatile memory 120 as is discussed below with reference to FIG. 6. While nonvolatile memory 120 is performing the reclaim operation, processor 110 may be free to process or execute another operation or task, for example, a non-reclaim operation such as, for example, another memory operation or an operation that does not involve memory 120 (flow diagram block 530).

At some later point in time, the software running on processor 110 may determine if the reclaim operation is complete (flow diagram block 540). As is discussed below, nonvolatile memory 120 may provide an indication that the reclaim operation is complete. For example, hardware and software internal to nonvolatile memory 120 may send an interrupt signal to processor 110 to indicate the reclaim operation is complete. Next, the software running on processor 110 may map the reclaimed block, that is, block 143, to be the new spare block (flow diagram block 550) as is illustrated in FIG. 7.

Turning to FIG. 8, what is shown is a flow diagram illustrating a method 800 to perform a reclaim operation in a nonvolatile memory in accordance with an embodiment of the present invention. This method will be described with reference to system 100 of FIG. 1.

In one embodiment, all steps of method 800 may be performed by hardware, and optionally software, resources internal to nonvolatile memory 120. For example, controller 170 may be used to implement method 800. As mentioned above, controller 170 may include circuitry, for example, digital logic, and may optionally execute code (for example, microcode or firmware) that may be used to perform reclaim operations.

Method 800 may begin with receiving the reclaim request (flow diagram block 810) from processor 110, which is external to nonvolatile memory 120. As will be discussed in more detail below, the reclaim operation performed by resources internal to nonvolatile memory 120 may include copying valid information stored in one portion of nonvolatile memory 120, for example, reclaim block 143, to another portion of nonvolatile memory 120, for example, spare block 145, and erasing block 143 after the copying of the valid information from block 143 to spare block 145.

Method 800 will also be described with reference to FIGS. 9 and 10. FIG. 9 illustrates colonies 151-156 of reclaim block 143 and their corresponding colony status cells 161-166 prior to the reclaim operation. FIG. 10 illustrates colonies 181-186 of spare block 145 and their corresponding colony status cells 191-196 after the reclaim operation. As may be appreciated, since spare block 145 is an erased block, spare block includes erased colonies having their corresponding colony status bits set to a valid state prior to copying valid information from reclaim block 143.

Turning back to FIG. 8, after receiving the reclaim request from processor 110, controller 170 may scan the colony status bits stored in colony status cells 161-166 associated with the colonies of selected reclaim block 143 to determine which, if any, colonies of selected reclaim block 143 include valid information (flow diagram block 820). For example, starting with colony status cell 161, controller 170 may include circuitry to sequentially check each colony status cell associated with block 143 to determine if the colony associated with status cell 161, that is, colony 151, contains valid information (diamond 830).

In the example illustrated in FIG. 9, colony 151 does not include valid information as denoted by the status bit stored in colony status cell 161. Since colony 151 includes invalid data, controller 170 may next determine whether the current colony being examined is the last colony of selected reclaim block 143 (diamond 840). Next, controller 170 of nonvolatile memory 120 checks the colony status bit stored in colony status cell 162 to determine whether colony 152 includes valid data. In this example, colony 152 does include valid data as denoted by the status bit stored in colony status cell 162.

As is illustrated in FIGS. 9 and 10, since colony 162 includes valid data, controller 170 may next copy the valid information from colony 162 to colony 182 of spare block 145 (flow diagram block 850). As is illustrated in FIG. 8, invalid information stored in block 143 is not copied to spare block 145, accordingly, the space occupied by the invalid information is effectively reclaimed as the new block, that is, block 145, will include erased colonies that correspond to colonies of reclaim block 143 that contained invalid information.

Controller 170 again determines whether the current colony being examined is the last colony of selected reclaim block 143 (diamond 840). This sequence is repeated until all status bits stored in status cells 161-166 are examined. As is illustrated in the example shown in FIGS. 9 and 10, the valid data stored in colonies 152, 154, and 155 is copied to colonies 182, 184, and 185 of spare block 145.

After controller 170 examines the status bit stored in status cell 166 and determines that this is the last colony of reclaim block 143, controller 170 may next erase reclaim block 143 (flow diagram block 860). That is, all colonies 151-156 of block 143 may be erased.

Controller 170 of nonvolatile memory 120 may include circuitry to set all status bits associated with all colonies 151-156 of selected reclaim block 143 to a valid state to indicate that the status of all colonies of block 143 is valid (flow diagram block 870), wherein controller 170 sets all the colony status bits of block 143 after the reclaim operation for block 143 is complete.

Next, controller 170 may include circuitry to provide an indication to the memory management software that is executed on processor 110, which is external to nonvolatile memory 120, to indicate that the reclaim operation is complete (flow diagram block 880). In one embodiment, controller 170 may provide an interrupt signal to processor 110 to indicate the reclaim operation is complete. In another embodiment, controller 170 may set a reclaim complete bit stored in nonvolatile memory 120 to indicate that the reclaim operation is complete. In this embodiment, the memory management software running on processor 110 may check the reclaim complete bit to see if the reclaim operation is completed(flow diagram block 540 of FIG. 5).

In another embodiment, the reclaim operation performed by resources internal to memory 120 may include copying valid information from the selected reclaim block to a “hidden” block that is not mapped. After the valid information is copied to the hidden block, a swap operation may be performed by software running on processor 110 to map the hidden block in place of the selected reclaim block and to unmap the reclaim block.

As is discussed above, methods and apparatuses are disclosed that include using resources internal to nonvolatile memory 120 to perform a reclaim operation. For example, the hardware of memory 120, and optionally software executed internal to memory 120, may be used to perform a reclaim operation.

Compared to an implementation that uses software running on a processor external to memory 120, such as, for example, flash management software, to implement a reclaim operation, it may be advantages to perform the reclaim operation using resources internal to memory 120. For example, the reclaim operation, which may take several milliseconds to complete, may now be performed in the background without the intervention of software running on processor 110.

By performing the reclaim operation in the memory hardware and utilizing the capabilities of the memory hardware, this may free up processor cycles so that processor 110 may perform other, non-reclaim operations/tasks. In other words, in some embodiments, the present invention allows the memory hardware to internally handle a reclaim operation. This may make the reclaim operation a background operation that may hide the reclaim operation from the rest of system 100. As discussed above, the resources internal to nonvolatile memory 120 may maintain colony status bits that may be used to determine whether information stored in a reclaim block is valid, and may then copy the valid information to a spare block.

Turning to FIG. 11, shown is a block diagram illustrating a wireless device 600 in accordance with an embodiment of the present invention. In one embodiment, wireless device 600 may use the methods discussed above and may include computing system 100 (FIG. 1).

As is shown in FIG. 11, wireless device 600 may include an antenna 620 coupled to a processor of system 100, for example, processor 110, via a wireless interface 630. In various embodiments, antenna 620 may be a dipole antenna, helical antenna or another antenna adapted to wirelessly communicate information. Wireless interface 630 may be adapted to process radio frequency (RF) and baseband signals using wireless protocols and may include a wireless transceiver.

Wireless device 600 may be a personal digital assistant (PDA), a laptop or portable computer with wireless capability, a web tablet, a wireless telephone (for example, cordless or cellular phone), a pager, an instant messaging device, a digital music player, a digital camera, or other devices that may be adapted to transmit and/or receive information wirelessly. Wireless device 600 may be used in any of the following systems: a wireless personal area network (WPAN) system, a wireless local area network (WLAN) system, a wireless metropolitan area network (WMAN) system, or a wireless wide area network (WWAN) system such as, for example, a cellular system.

An example of a WLAN system includes a system substantially based on an Industrial Electrical and Electronics Engineers (IEEE) 802.11 standard. An example of a WMAN system includes a system substantially based on an Industrial Electrical and Electronics Engineers (IEEE) 802.16 standard. An example of a WPAN system includes a system substantially based on the Bluetooth™ standard (Bluetooth is a registered trademark of the Bluetooth Special Interest Group). Another example of a WPAN system includes a system substantially based on an Industrial Electrical and Electronics Engineers (IEEE) 802.15 standard such as, for example, the IEEE 802.15.3a specification using ultrawideband (UWB) technology.

Examples of cellular systems include: Code Division Multiple Access (CDMA) cellular radiotelephone communication systems, Global System for Mobile Communications (GSM) cellular radiotelephone systems, Enhanced data for GSM Evolution (EDGE) systems, North American Digital Cellular (NADC) cellular radiotelephone systems, Time Division Multiple Access (TDMA) systems, Extended-TDMA (E-TDMA) cellular radiotelephone systems, GPRS, third generation (3G) systems like Wide-band CDMA (WCDMA), CDMA-2000, Universal Mobile Telecommunications System (UMTS), or the like.

Although computing system 100 is illustrated as being used in a wireless device in one embodiment, this is not a limitation of the present invention. In alternate embodiments system 100 may be used in non-wireless devices such as, for example, a server, a desktop, or an embedded device not adapted to wirelessly communicate information.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A nonvolatile memory, comprising:
a control circuit to receive a reclaim request from a device external to the nonvolatile memory and to perform a reclaim operation in response to receiving the reclaim request, wherein the reclaim operation includes copying valid information stored in a first portion of the nonvolatile memory to a second portion of the nonvolatile memory and erasing the first portion of the nonvolatile after the copying of the valid information.

2. The nonvolatile memory of claim 1,
wherein the nonvolatile memory is adapted to store memory management software;
wherein the external device is a microprocessor adapted to execute the memory management software; and
wherein the memory management software determines which portion of the nonvolatile memory is selected for reclaiming and initiates the reclaim request which includes an address to indicate that the first portion of the nonvolatile memory is selected for reclaiming.

3. The nonvolatile memory of claim 1, wherein the control circuit is a 8-bit microcontroller.

4. The nonvolatile memory of claim 1, wherein the nonvolatile memory is a flash electrically erasable programmable read-only memory (EEPROM).

5. The nonvolatile memory of claim 1,
wherein the nonvolatile memory includes a memory array that includes a plurality of memory blocks;
wherein each block of the plurality of memory blocks includes a plurality of colonies;
wherein each colony of the plurality of colonies includes a plurality of nonvolatile memory cells;
wherein the nonvolatile memory includes a plurality of nonvolatile status cells;
wherein each nonvolatile status cell of the plurality of nonvolatile status cells corresponds to one colony of the plurality of colonies; and
wherein each nonvolatile status cell of the plurality of nonvolatile status cells stores at least one status bit to indicate whether information stored in each colony of the plurality of colonies includes valid information.

6. The nonvolatile memory of claim 5, wherein the memory array includes at least about 128 memory blocks, wherein each memory block of the plurality of memory blocks is at least about 16 kilobytes in size, and wherein each colony of the plurality of colonies is at least about 512 bytes in size.

7. The nonvolatile memory of claim 5, wherein the reclaim operation comprises:
scanning the plurality of status cells associated with the colonies of a selected block of the plurality of memory blocks to determine if a colony of the selected block includes valid information; and
copying the valid information from the colonies of the selected block that include valid information to a spare block of the plurality of memory blocks in the nonvolatile memory; and
erasing the selected block to reclaim the selected block.

8. The nonvolatile memory of claim 7, wherein the control circuit includes circuitry to set all status bits associated with all colonies in the selected block of the nonvolatile memory to a valid state to indicate that the status of all colonies of the selected block is valid, wherein the control circuit sets all the status bits of the selected block after the reclaim operation for the selected block is complete.

9. The nonvolatile memory of claim 5, wherein the external device is a microprocessor, and further comprising a write operation initiated by memory management software that is executed on the microprocessor to set a status bit associated with a first colony of the plurality of colonies to an invalid state.

10. The nonvolatile memory of claim 1, wherein the control circuit includes circuitry to provide an indication to memory management software that is executed on the device external to the nonvolatile memory to indicate that the reclaim operation is complete.

11. The nonvolatile memory of claim 10, wherein the control circuit provides a signal to the external device to indicate that the reclaim operation is complete.

12. The nonvolatile memory of claim 10, wherein the control circuit sets a bit stored in the nonvolatile memory to indicate that the reclaim operation is complete.

13. The nonvolatile memory of claim 1, wherein the external device is a 32-bit microprocessor.

14. The nonvolatile memory of claim 1, further comprising:
a memory array coupled to the control circuit; and
a write buffer coupled to the control circuit and the memory array of the nonvolatile memory.

15. The nonvolatile memory of claim 1, wherein the write buffer is capable of storing at least about 64 bytes of information.

16. The nonvolatile memory of claim 1, wherein the control circuit includes circuitry to write to, read from, or erase the plurality of nonvolatile memory cells.

17. The nonvolatile memory of claim 1, wherein the nonvolatile memory is a ferroelectric random access memory (FRAM) or a magnetic random access memory (MRAM).

18. A system, comprising:
a processor;
an antenna coupled to the processor; and
a flash electrically erasable programmable read-only memory (EEPROM) coupled to the processor, wherein the flash EEPROM comprises a control circuit to receive a reclaim request from a device external to the nonvolatile memory and to perform a reclaim operation in response to receiving the reclaim request, wherein the reclaim operation includes copying valid information stored in a first portion of the nonvolatile memory to a second portion of the nonvolatile memory and erasing the first portion of the nonvolatile after the copying of the valid information.

19. The system of claim 18, wherein the system is a wireless phone.

20. The system of claim 18,
wherein the flash EEPROM includes a memory array that includes a plurality of memory blocks;
wherein each block of the plurality of memory blocks includes a plurality of colonies;
wherein each colony of the plurality of colonies includes a plurality of nonvolatile flash memory cells;
wherein the flash EEPROM includes a plurality of nonvolatile status cells;
wherein each nonvolatile status cell of the plurality of nonvolatile status cells corresponds to one colony of the plurality of colonies; and
wherein each nonvolatile status cell of the plurality of nonvolatile status cells stores at least one status bit to indicate whether information stored in each colony of the plurality of colonies includes valid information.

21. The system of claim 20, wherein the reclaim operation comprises:
scanning the plurality of status cells associated with the colonies of a selected block of the plurality of memory blocks to determine if a colony of the selected block includes valid information; and
copying the valid information from the colonies of the selected block that include valid information to a spare block of the plurality of memory blocks in the flash EEPROM; and
erasing the selected block to reclaim the selected block.

22. A method, comprising:
performing a reclaim operation in a nonvolatile memory using a controller internal to the nonvolatile memory, wherein the reclaim operation includes copying valid information stored in a first portion of the nonvolatile memory to a second portion of the nonvolatile memory and erasing the first portion of the nonvolatile memory after the copying of the valid information.

23. The method claim 22, wherein the controller provides an indication to memory management software executing on a processor external to the nonvolatile memory to indicate the reclaim operation is complete, wherein the memory management software is stored in the nonvolatile memory and wherein the processor executes a non-reclaim operation while the controller of the nonvolatile memory performs the reclaim operation.

24. The method of claim 22,
wherein memory management software executing on a processor external to the nonvolatile memory determines which portion of the nonvolatile memory to reclaim;
wherein performing includes performing the reclaim operation in a nonvolatile flash memory using the controller internal to the nonvolatile flash memory in response to receiving a reclaim request from the memory management software; and
wherein the reclaim request is initiated by the memory management software, and the reclaim request includes an address to indicate that the first portion of the nonvolatile memory is selected for reclaiming.

25. The method of claim 22,
wherein the nonvolatile memory includes a memory array that includes a plurality of memory blocks;
wherein each block of the plurality of memory blocks includes a plurality of colonies;
wherein each colony of the plurality of colonies includes a plurality of nonvolatile memory cells;
wherein the nonvolatile memory includes a plurality of nonvolatile status cells;
wherein each nonvolatile status cell of the plurality of nonvolatile status cells corresponds to one colony of the plurality of colonies; and
wherein each nonvolatile status cell of the plurality of nonvolatile status cells stores at least one status bit to indicate whether information stored in each colony of the plurality of colonies includes valid information.

26. The method of claim 25, wherein the reclaim operation performed by the controller includes:
scanning the plurality of status cells associated with the colonies of a selected block of the plurality of memory blocks to determine if a colony of the selected block includes valid information; and
copying the valid information from the colonies of the selected block that include valid information to a spare block of the plurality of memory blocks in the nonvolatile memory; and
erasing the selected block to reclaim the selected block.

27. The method of claim 26, wherein the controller sets all status bits associated with all colonies in the selected block of the nonvolatile memory to a valid state to indicate that the status of all colonies of the selected block is valid, wherein the control circuit sets all the status bits of the selected block after the reclaim operation for the selected block is complete.
